(19) United States
(12) Patent Application Publication
(10) Pub. No.: US 2002/0104337 A1
(43) Pub. Date: Aug. 8, 2002

(54) Combination lock

(76) Inventor: Lambert Kuo, Tainan (TW)

Correspondence Address: Jackson Walker L. L. P., Suite 2100, 112 E. Pecan Street, San Antonio, TX, 78205, US

(21) Appl. No.: 09/777,381

(22) Filed: Feb. 6, 2001

(51) Int. Cl. E05B 37/02

(52) U.S. Cl. 70/30; 70/312

(57) ABSTRACT

A combination lock includes a male bolt and a female body for receiving and releasably locking the male bolt. The female body includes a cylindrical core having an enlarged front end and a rear end, with the enlarged front end defining a channel in which the male bolt may be inserted. A set of dials is mounted around the cylindrical core between the enlarged front end and a retainer. A spring has a tendency to move the rotary ring from the second axial position to the first axial position, while the retainer is formed with a button adapted to move the inner rotary ring from the first axial position to the second axial position. Therefore, the combination of the lock can be reset or changed by rotating the outer dial rings while retaining the inner rings in a non-rotatable mode after the button is pressed down.

### BACKGROUND OF THE INVENTION

1. Field of the Invention

The present invention relates to a combination lock and, more particularly, to a combination lock in which its combination can be reset or changed easily.

2. Description of Related Art

There are various combination locks well known in the art. Such a lock with a resettable combination is disclosed in U.S. Pat. No. 5,934,120, which includes a cable with a locating head at one end and a locking head at the other end. The locking head has a rod formed with a toothed bar, and the locating head is provided for receiving the rod and releasably locking with the toothed bar.

In this lock, however, the heads are necessary to be separate from each other to reset or change the combination from a previous one to a new one. More seriously, it can be found that the rod of the locking head will never be admitted into the locating head after the resetting procedure, resulting in uselessness of the lock.

Therefore, it is an objective of the invention to provide a combination lock to mitigate and/or obviate the aforementioned problems.

### SUMMARY OF THE INVENTION

The object of the present invention is to provide a combination lock in which the combination can be reset or changed.

Another object of the present invention is to provide a combination lock in which the combination can be reset or changed easily.

Other objects, advantages and novel features of the invention will become more apparent from the following detailed description when taken in conjunction with the accompanying drawings.

### BRIEF DESCRIPTION OF THE DRAWINGS

FIG. 1 is a plan view of a preferred embodiment of a combination lock in accordance with the present invention;

FIG. 2 is an exploded view of the combination lock shown in FIG. 1;

FIG. 3 is a fragmentary cross-sectional view cut away vertically from FIG. 1, showing an inner rotary ring being in a first axial position;

FIG. 4 is a fragmentary cross-sectional view cut away horizontally from FIG. 1, showing the inner rotary ring being in the first axial position; and

FIG. 5 is a fragmentary cross-sectional view cut away vertically from FIG. 1, showing the inner rotary ring being in a second axial position;

### DETAILED DESCRIPTION OF THE PREFERRED EMBODIMENT

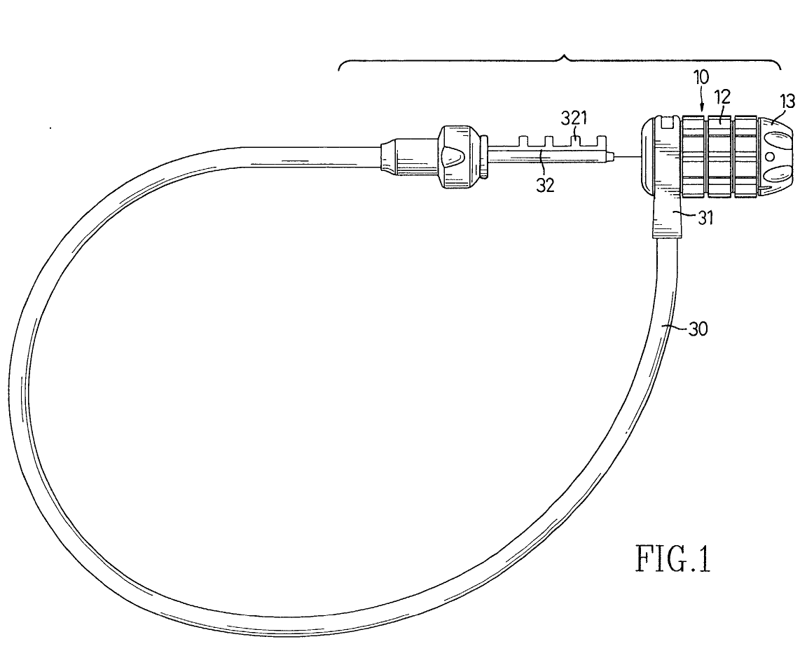

Referring to FIG. 1, a combination lock in accordance with the present invention includes a wire rope (30) with a male bolt (32) at a first end and a female body (10) at a second end. The male bolt (32) is formed with a row of projecting bits (321), whereas the female body (10) is provided for receiving the male bolt (32) and releasably locking with the projecting bits (321).

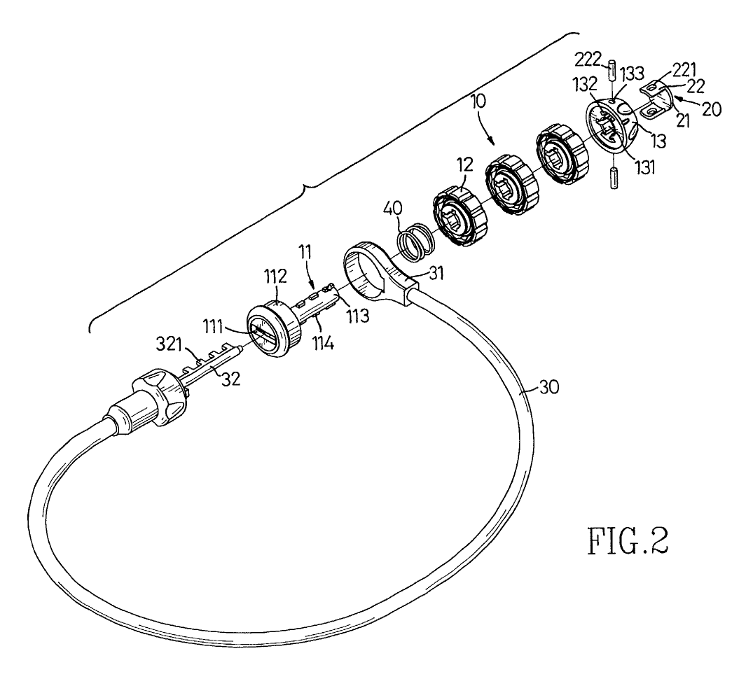

Referring to FIG. 2, the female body (10) includes a cylindrical core (11) having an enlarged front end (112) and a rear end (113), with two lines of regularly spaced cogs (114) arranged axially along the core (11) between the ends (112,113).

The enlarged front end (112) defines a channel (111) which extends along the cylindrical core (11) and is defined so that the male bolt (32) may be inserted therein with the projecting bits (321) protruded from an outer periphery of the core (11). Additionally, the enlarged end (112) may define a neck (not numbered) therein, and the second end of the wire rope (30) may be formed with a loop (31) held in the neck so as to be attached to the cylindrical core (11) and hence the female body (10).

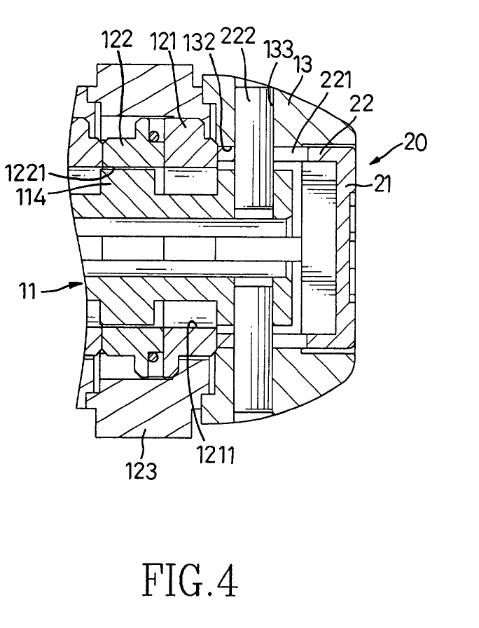

A set of dials (12) is mounted around the cylindrical core (11) sequentially between the enlarged front end (112) and a retainer (13) fastened to the rear end (113) of the core (11). As illustrated, the retainer (13) defines a central hole (131) to receive the rear end (113) of the core (11), and a pair of diametrical groves (132) symmetrical about the central hole (131). The retainer (13) is fastened to rear end (113) of the core (11), preferably by a pair of pins (222) that extend into the core (11) through transverse apertures (133) defined in the retainer (13), as best shown in FIG. 4.

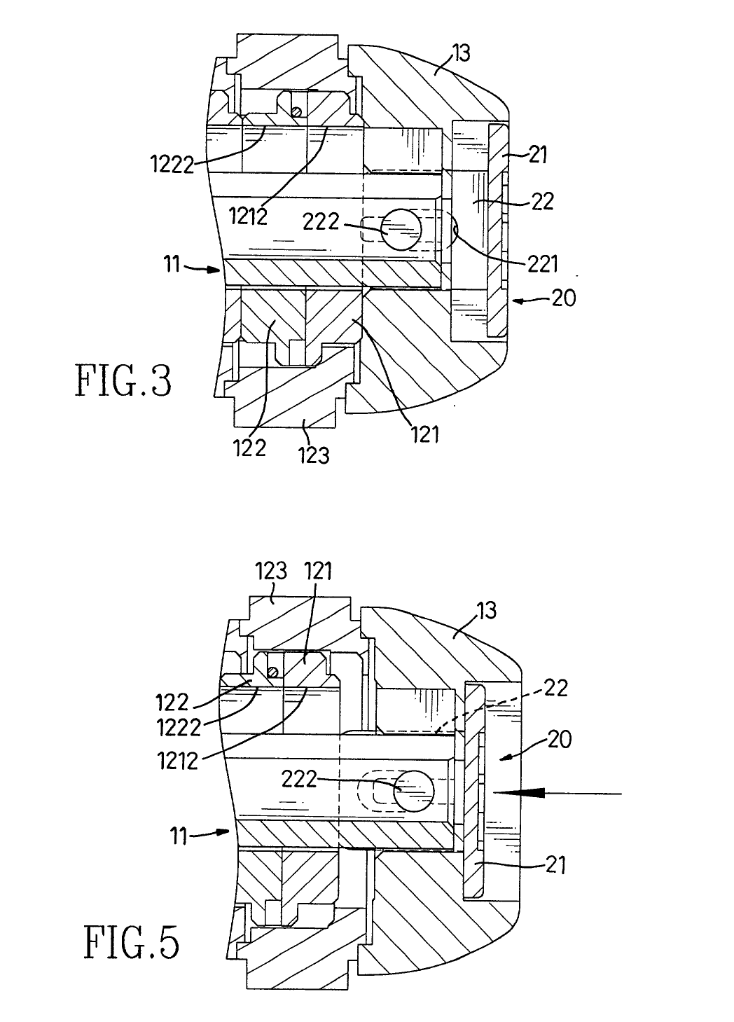

Referring to FIGS. 3 and 4, each of the dials (12) has an inner rotary ring (121) and an inner dead ring (122) both snugly fitted around the core (11), and an outer dial ring (123) selectively coupled with the inner rotary ring (121) such as in toothed connection.

Each inner dead ring (122) defines a pair of first slots (1221) receiving respective cogs (114), as shown in FIGS. 2 and 3, and is non-rotatable substantially about but movable along the cylindrical core (11). Each inner dead ring (122) further defines therein a first trough (1222) always aligned with the channel (111) of the cylindrical core (11) for receiving one of the projecting bits (321) of the male bolt (32).

However, each inner rotary ring (121) is normally located on the cylindrical core (11) in a first axial position, i.e. in a space between an adjacent two of the spaced cogs (114) involved in each line and thus is rotatable about the cylindrical core (11), as well as being coupled with the outer dial ring (123). The rotary ring (121) is normally retained in this fist axial position, preferably by a spring (40) mounted around the cylindrical core (11) and compressed between the enlarged front end (112) and the inner dead ring (122) of the foremost dial (12), as shown in FIG. 2.

Each inner rotary ring (121) defines therein a second trough (1212), which is aligned with the channel (111) of the cylindrical core (11) for allowing one or more projecting bits (321) of the male bolt (32) to pass therethrough when the inner rotary ring (121) is rotated to a particular angular position in correspondence with the rotation of the outer dial ring (123).

The second trough (1212) may misalign with the channel (111) of the cylindrical core (11) for blocking the way of the one or more projecting bits (321) to exit from the female body (10) when the inner rotary ring (121) is rotated away from the particular angular position in correspondence with the rotation of the outer dial ring (123).

Obviously, the particular angular position is associated with the combination preset by the manufacturer or the latest one previously set by the user.

Like the dead ring (122), each rotary ring (121) further defines a pair of second slots (1211), which will be aligned with the lines of spaced cogs (14) as the second trough (1212) is being aligned with the channel (111) of the cylindrical core (11). Furthermore, the second slots (1211) are dimensioned to admit the cogs (14), thereby allowing the inner rotary ring (121), together with the dead ring (122), to be movable along the cylindrical core (11) from the first axial position shown in FIG. 3 to a second axial position shown in FIG. 5 after the inner rotary ring (121) has been rotated exactly to the particular angular position.

Referring to FIG. 5, the rotary ring (121) is non-rotatable and is uncoupled from the outer dial ring (123) in this second axial position. Now the combination, either preset or previously set, can be reset or changed desirably into a new one by rotating the outer dial ring (123) with respect to the inner rings (121,122), which have now become non-rotatable.

The inner rotary ring (121), together with the dead ring (122), will be moved back along the cylindrical core (11) from the second axial position to the first axial position under the action of the above-mentioned spring (40).

The inner rotary ring (121) and the outer dial ring (123) are preferably configured in such a way for their toothed connection that the inner rotary ring (121) becomes non-rotatable shortly before being uncoupled from the outer dial ring (123) during its forward movement from the first axial position to the second axial position, and becomes rotatable shortly after being coupled with the outer dial ring (123) again during its backward movement from the second axial position to the first axial position. This ensures the reliability for the change of the combination.

In the inventive combination lock, the forward movement of the inner rings (121,122) is performed by a button (20) formed in the retainer (13). The button (20) is configured as a disk (21) having two extensions (22) that extend through the diametrical groves (132) of the retainer (13) to move the inner rotary ring (121) from the first axial position to the second axial position against the action of the spring (40). Additionally, the extensions (22) define respective oblong openings (221) through which the pins (222) extend, and so the button (20) can be moved relative to the retainer (13) or pressed down, as also shown in FIG. 2.

In this configuration, whenever the male bolt (32) is separate from or locked with the female body (10), the combination can be reset desirably by rotating the outer dial rings (123) while retaining the inner rings (121,122) in a non-rotatable mode after the dials (12) were rotated in accordance with the preset one and the button (20) has been pressed down.

From the above description, it is noted that the invention has the following advantages:

1. real ability for the combination to be reset:

Because the inner rings (121,122) are retained in a non-rotatable mode during the resetting process, the combination for the lock can be reset or changed.

2. convenience for resetting the combination:

Because the button (20) is available directly from the retainer (13), the combination can be reset or changed without having to separate the male body (32) from the female body (10).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A combination lock comprising a male bolt (32) with a row of projecting bits (321) and a female body (10) for receiving said male bolt (32) and releasably locking with said projecting bits (321), wherein the improvements comprise:
said female body (10) having:
a cylindrical core (11) having an enlarged front end (112) and a rear end (113), said enlarged front end (112) defining a channel (111) extending along and open to the exterior of said cylindrical core (11), said channel (111) being defined so that said male bolt (32) may be inserted therein with said projecting bits (321) protruded from an outer periphery of said core (11);
a retainer (13) fastened to said cylindrical core (11) at said rear end (113);
a set of dials (12) mounted around said cylindrical core (11) sequentially between said enlarged front end (112) and said retainer (13), each of said dials (12) having an inner dead ring (122) and an inner rotary ring (121) both fitted snugly around said core (11), and an outer dial ring (123) selectively coupled with said inner rotary ring (121);
said inner dead ring (122) being non-rotatable about but movable along said cylindrical core (11), said inner dead ring (122) defining a first trough (1222) always aligned with said channel (111) of said cylindrical core (11) for receiving one of said projecting bits (321) of said male bolt (32);
said inner rotary ring ( 121) being normally located on said cylindrical core (11) in a first axial position in which said inner rotary ring (121) is rotatable about said cylindrical core (11) and is coupled with said outer dial ring (123), said inner rotary ring (121) having a second trough (1212) defined therein;
said second trough (1212) being aligned with said channel (111) of said cylindrical core (11) for allowing at least one of said projecting bits (321) of said male bolt (32) to pass therethrough when said inner rotary ring (121) is rotated to a particular angular position by said outer dial ring (123);
said second trough (1212) being misaligned to said channel (111) of said cylindrical core (11) for blocking the way of said at least one of said projecting bits (321) to exit from said female body (10) when said inner rotary ring (121) is rotated away from said particular angular position by said outer dial ring (123);
said inner rotary ring (121) being movable along said cylindrical core (11) between said first axial position and a second axial position, in which said inner rotary ring (121) is non-rotatable about said cylindrical core (11) and is uncoupled from said outer dial ring (123) after said inner rotary ring (121) has been rotated to said particular angular position;
a spring (40) having a tendency to move said inner rotary ring (121) from said second axial position to said first axial position;
said retainer (13) being formed with a button (20) to move said inner rotary ring (121) from said first axial position to said second axial position against the action of said spring (40); and
whereby the combination of said lock can be reset desirably by rotating said outer dial rings (123) while retaining said inner rings (121,122) in a non-rotatable mode after said dials (12) were rotated in accordance with a preset one and said button (20) has been pressed down.

2. The combination lock as claimed in claim 1, wherein said inner rotary ring (121) and said outer dial ring (123) are configured so that said inner rotary ring (121) becomes non-rotatable shortly before being uncoupled from said outer dial ring (123) during its movement from said first axial position to said second axial position, and becomes rotatable shortly after being coupled with said outer dial ring (123) again during its movement from said second axial position to said first axial position.

3. The combination lock as claimed in claim 2, wherein said cylindrical core (11) has at least one line of regularly spaced cogs (114) arranged axially therealong between said ends (112,113), and wherein said inner dead ring (122) has a first slot (1221) receiving a corresponding one of said spaced cogs (114), thereby being non-rotatable about but movable along said cylindrical core (11).

4. The combination lock as claimed in claim 3, wherein said inner rotary ring (121) is normally located on said cylindrical core (11) in a space defined between an adjacent two of said spaced cogs (114) and is thus rotatable about said cylindrical core (11), and wherein said space is defined in such a location on said cylindrical core (11) that said inner rotary ring (121) may be normally coupled with said outer dial ring (123), thereby defining said first axial position of said inner rotary ring (121).

5. The combination lock as claimed in claim 4, wherein said inner rotary ring (121) has a second slot (1211) defined therein, and wherein said second slot (1211) is aligned with said line of spaced cogs (14) while said second trough (1212) is aligned with said channel (111) of 16 said cylindrical core (11), thereby ensuring that said inner rotary ring (121) is movable along said cylindrical core (11) between said first axial position and said second axial position after said inner rotary ring (121) has been rotated to said particular angular position.

6. The combination lock as claimed in claim 1, wherein said retainer (13) has a pair of diametrical groves (132) defined therein, and wherein said button (20) has two extensions (22) extending through said diametrical groves (132) to move said inner rotary ring (121) from said first axial position to said second axial position;

7. The combination lock as claimed in claim 1 further including a wire rope (30) having a first end attached to said male bolt (32) and a second end attached to said female body (10).

8. The combination lock as claimed in claim 7, wherein said female body (10) has a neck defined in said enlarged front end (112) thereof, and wherein said wire rope (30) is formed at said second end with a loop (31) adapted to be held in said neck, thereby attaching said second end of said wire rope (30) to said female body (10).
